(19) United States
(12) Patent Application Publication
(10) Pub. No.: US 2009/0295709 A1
(43) Pub. Date: Dec. 3, 2009

(54) Electrophoretic Display

(76) Inventors: Ted-Hong SHINN, Hsinchu City (TW); Chi-Tsan Shen, Hsinchu City (TW)

Correspondence Address: HDLS Patent & Trademark Services, P.O. BOX 220746, CHANTILLY, VA, 20153-0746, US

(21) Appl. No.: 12/180,327

(22) Filed: Jul. 25, 2008

(30) Foreign Application Priority Data
May 30, 2008 (TW) 097120226

(51) Int. Cl. G09G 3/34

(52) U.S. Cl. 345/107

(57) ABSTRACT

An electrophoretic display includes a display region. The display region includes a plurality of pixels. Each pixel includes a plurality of sub-pixels. Each sub-pixel has a plurality of charged particles. The charged particles of the sub-pixels of each pixel exhibit the same color. The sub-pixels of each pixel are capable of displaying different gray levels in a frame time.

### BACKGROUND

1. Technical Field

The present invention relates to a display, and in particular relates to an electrophoretic display.

2. Description of the Related Art

An electrophoretic display generally includes a plurality of charged particles dispersed in an electrophoretic layer. The charged particles are migrated under the influence of an electric field in order to display data and images. With the progress of display technique, the size of the electrophoretic display is increased. The electrophoretic display can be classified into two types of passive matrix type and active matrix type according to the driving manners. Typically, the large size electrophoretic display is classified as the active matrix type. Therefore, the large size electrophoretic display generally includes thin film transistor array substrate (TFT array substrate).

However, a display uniformity of the electrophoretic display is easily influenced by thin film transistors of the thin film transistor array substrate. In addition, some defects of a configuration of the electrophoretic layer or a coating on the electrophoretic layer (such as a thickness of the coating is not uniform) may also reduce the display uniformity of the electrophoretic display.

### BRIEF SUMMARY

The present invention relates to an electrophoretic display for improving the display uniformity.

In order to achieve the above-mentioned advantages, an electrophoretic display including a display region is provided. The display region includes a plurality of pixels. Each pixel includes a plurality of sub-pixels. Each sub-pixel has a plurality of charged particles. The charged particles of the sub-pixels of each pixel exhibit the same color. The sub-pixels of each pixel are capable of displaying different gray levels in a frame time.

In an embodiment of the present invention, the pixels exhibit the same color.

In an embodiment of the present invention, the pixels exhibit different colors.

In an embodiment of the present invention, the sub-pixels of each pixel are aligned on a straight line.

In an embodiment of the present invention, the sub-pixels of each pixel are arranged in an array.

In the above electrophoretic display, the plurality of sub-pixels of each pixel are capable of displaying different gray levels in the frame time, and a gray level of each pixel is a blend of the plurality of sub-pixels. Therefore, display uniformity of the electrophoretic display can be improved.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic top plan view of an electrophoretic display according to a first exemplary embodiment of the present invention.

FIG. 2 is a partially cross-sectional view of the electrophoretic display of FIG. 1.

FIG. 3 is a schematic view of a pixel of an electrophoretic display according to a second exemplary embodiment of the present invention.

FIG. 4 is a graph of display uniformity testing of a conventional electrophoretic display and the electrophoretic display of FIG. 3.

FIG. 5 is a schematic view of a plurality of pixels of an electrophoretic display according to a third exemplary embodiment of the present invention.

### DETAILED DESCRIPTION

Reference will now be made to the drawings to describe various exemplary embodiments of the present electrophoretic displays in detail.

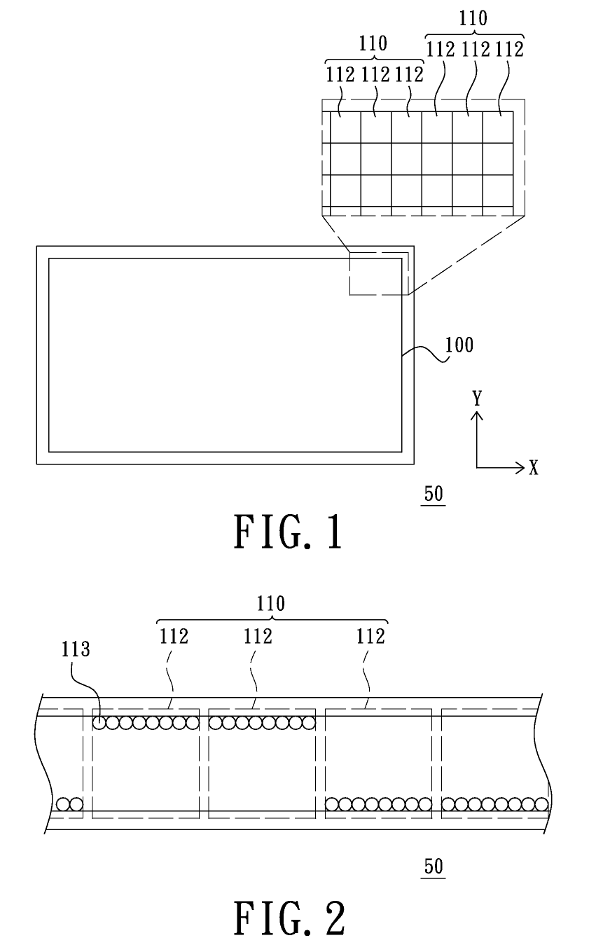

FIG. 1 is a schematic top plan view of an electrophoretic display according to a first exemplary embodiment of the present invention, and FIG. 2 is a partially cross-sectional view of the electrophoretic display of FIG. 1. Referring to FIGS. 1 and 2, the electrophoretic display 50 includes a display region 100. The display region 100 includes a plurality of pixels 110. Each pixel 110 includes a plurality of sub-pixels 112. Each sub-pixel 112 has a plurality of charged particles 113. The charged particles 113 of the sub-pixels 112 of each pixel 110 exhibit the same color. The sub-pixels 112 of each pixel 110 are capable of displaying different gray levels in a frame time.

In a described embodiment, all the pixels 110 have the same color, so the charged particles 113 of the sub-pixels 112 of all the pixels 110 exhibit the same color. In other words, the electrophoretic display 50 is a monochrome display. Each pixel 110 includes three sub-pixels 112. The sub-pixels 112 of each pixel 110 are aligned on a straight line that is parallel to an X-axis. In alternative embodiments, each pixel 110 can include four or more sub-pixels 112, and the sub-pixels 112 of each pixel 110 can be aligned on another straight line that is parallel to a Y-axis.

In use, the plurality of sub-pixels 112 of each pixel 110 are capable of displaying different gray levels in the frame time, and a gray level of each pixel 110 is a blend of the plurality of sub-pixels 112. Therefore, a display uniformity of the electrophoretic display 50 can tolerance more defects/influence, which come/comes from, such as thin film transistors of the electrophoretic display 50, a configuration of the electrophoretic layer of the electrophoretic display 50, or a coating on the electrophoretic layer of the electrophoretic display 50. In this reason, the display uniformity of electrophoretic display 50 would be improved.

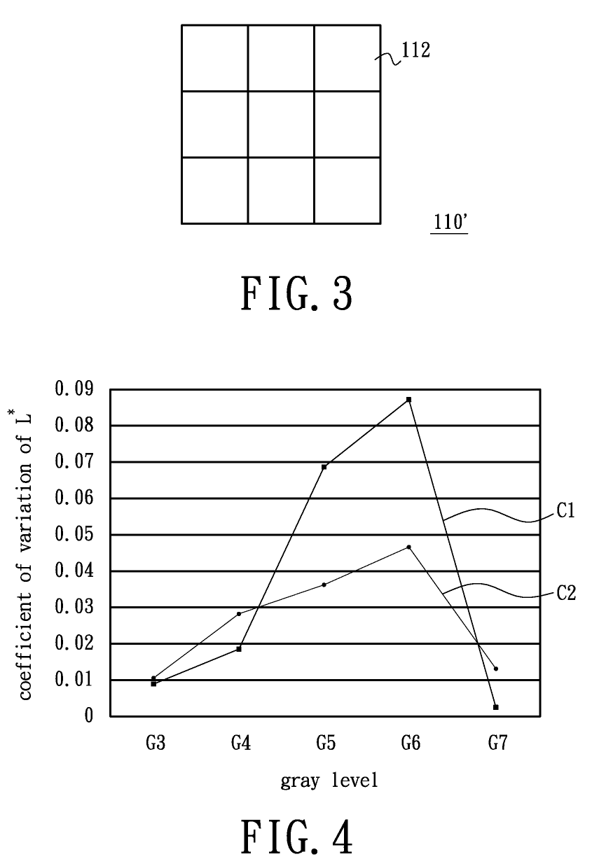

It should be pointed out that, the present electrophoretic display 50 is not limited by a form of an arrangement of the sub-pixels 112. For example, the sub-pixels 112 can also be arranged in an array. Referring to FIG. 3, a single pixel 110′ of an electrophoretic display according to a second exemplary embodiment is shown. The electrophoretic display of the second exemplary embodiment is similar in principle to the electrophoretic display 50 described above. However, the pixel 110′ includes nine sub-pixels 112. The nine sub-pixels 112 are arranged in an array.

Referring to FIG. 4, a graph of display uniformity testing of a conventional electrophoretic display and the electrophoretic display having the pixel 110′ of the second exemplary embodiment of the present invention are shown. An axis of abscissa represents a gray level. An axis of ordinates represents a coefficient of variation of L*. The L* represents a brightness index. Curves C1 and C2 respectively represent testing results of the conventional electrophoretic display and the electrophoretic display of the second exemplary embodiment. It can be seen that the coefficient of variations of L* of the curve C2 are much lower than that of the curve C1 in the middle (gray level G5, gray level G6). It can also be seen that an attenuation of the coefficient of variation of L* of the curve C2 changes more gradually than that of the curve C1 from gray level G3 to gray level G7. Therefore, in comparison to the conventional electrophoretic display, the electrophoretic display of the second exemplary embodiment of the present invention has an improving display uniformity.

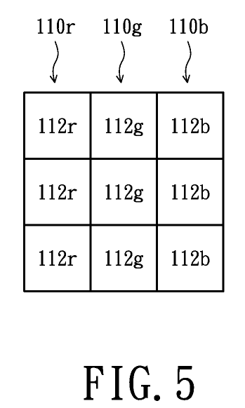

Referring to FIG. 5, a plurality of pixels of an electrophoretic display according to a third exemplary embodiment is shown. The electrophoretic display of the third exemplary embodiment is similar in principle to the electrophoretic display 50 described above. However, the electrophoretic display includes the plurality of pixels with different colors, such as red pixels 110r, green pixels 110g and blue pixels 110b. Each three of the red pixel 110r, the green pixel 110g and the blue pixel 110b can make up a color pixel. In another word, the electrophoretic display of the third exemplary embodiment of the present invention is a color electrophoretic display.

In addition, the red pixel 110r includes a plurality of red sub-pixels 112r. Charged particles (not shown) of the red sub-pixels 112r exhibit red. The green pixel 110g includes a plurality of green sub-pixels 112g. Charged particles (not shown) of the green sub-pixels 112g exhibit green. The blue pixel 110b includes a plurality of blue sub-pixels 112b. Charged particles (not shown) of the blue sub-pixels 112b exhibit blue.

Similar to the electrophoretic display 50 of the first exemplary embodiment, in the electrophoretic display of the third exemplary embodiment, the plurality of sub-pixels 112r, 112g and 112b of the pixel 110r, 110g and 110b correspondingly are capable of displaying different gray levels in the frame time, and the gray level of each of the pixel 110r, 110g and 110b is a blend of the plurality of sub-pixels 112r, 112g and 112b correspondingly. Therefore the electrophoretic display of the third exemplary embodiment can also have an improving display uniformity.

In summary, in the above electrophoretic displays of present invention, the plurality of sub-pixels of each pixel are capable of displaying different gray levels in the frame time, and the gray level of each pixel is the blend of the plurality of sub-pixels. Therefore the electrophoretic displays of present invention can have the improving display uniformity.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electrophoretic display comprising a display region, the display region including a plurality of pixels, each pixel including a plurality of sub-pixels, and each sub-pixel having a plurality of charged particles, wherein the charged particles of the sub-pixels of each pixel exhibit the same color, and the sub-pixels of each pixel are capable of displaying different gray levels in a frame time.

2. The electrophoretic display according to claim 1, wherein the pixels exhibit the same color.

3. The electrophoretic display according to claim 1, wherein the pixels exhibit different colors.

4. The electrophoretic display according to claim 1, wherein the sub-pixels of each pixel are aligned on a straight line.

5. The electrophoretic display according to claim 1, wherein the sub-pixels of each pixel are arranged in an array.
